(19) United States
(12) Patent Application Publication
(10) Pub. No.: US 2003/0150980 A1
(43) Pub. Date: Aug. 14, 2003

(54) Image intensifier tube of a simplified construction with a shutter electrode

(76) Inventors: Leonid Gaber, San Leandro, CA (US); Dmitry Naroditsky, San Francisco, CA (US); Marc Morgovsky, Foster City, CA (US); Dmitry Sokolov, Moscow (RU); Sergei Kuklev, Moscow (RU)

Correspondence Address: Leonid Gaber, Suite 1B, 20 South Linden Avenue, South San Francisco, CA, 94080, US

(21) Appl. No.: 10/062,915

(22) Filed: Jan. 31, 2002

(51) Int. Cl. H01J 40/14

(52) U.S. Cl. 250/214 VT

(57) ABSTRACT

The IIT of the present invention consists of the following parts arranged in series along the optical axis of the IIT in the direction from the target being observed to the viewer's eye: a fiber-glass plate having a flat side facing the object and a concave side facing the viewer, a thin-film coating applied onto the concave surface of the fiber-glass plate which functions as a photo-cathode, an anode made in the form of a truncated cone with the narrow side facing the photo-cathode, and a flat luminescent screen made of glass with a luminescent coating. Unique parts of the IIT of the invention are a specially profiled and dimensioned anode and shutter electrode. The anode and the shutter electrode have specific relationships between the diameters and lengths of the portions from which this parts are composed. The aforementioned specific relationships between the dimensions and shapes make it possible for the IIT to achieve the maximal resolution capacity and the coefficient of shuttering in pulse mode of operation along with the minimal electrical capacitance of the shutter electrode and with the minimal shutter electrode voltage. The characteristics achieved in the IIT of the present invention are unattainable with the use of known IITs of similar type or generation.

### FIELD OF INVENTION

The present invention relates to optical devices, in particular to image intensifying tubes of simplified construction with a shutter electrode. The image intensifying tubes of the invention may find application also in telescopic optical sights, intrusion control systems, geological surveying instruments, view finders, etc.

### BACKGROUND OF THE INVENTION

For better understanding of the invention, it would be advantageous first to consider main structural elements of a conventional image intensifier tube and the principle of its operation.

An image intensifier tube (IIT) is a vacuum photoelectronic device intended either for transformation of an invisible IR, UV, or X-ray image of an object into a visible image or for intensification of a visible image, especially for observation of objects or targets under poor vision conditions such as dusk or night. An IIT typically consists of a photocathode, an image intensification system, and a cathode-luminescent screen. The photocathode transforms the original optical image into a so-called electronic image. With the use of the image-intensifying system, the electronic image is transferred to the screen where this image, in turn, is converted into a visible original image. In the IIT, the light reflected from the object causes emission of electrons (photocurrent) from the surface of the photocathode. In this case, a magnitude of photocurrent generated by various areas of the photocathode depends on distribution of density of images projected onto these areas. Photoelectrons accelerated and focused by the IIT's field, bombard the screen and thus cause it to luminesce. Since brightness on individual areas of the screen depends on density of the photocurrent, the screen reproduces a visible image of the object.

In its simplest form, an IIT consists of two parallel electrodes, i.e., a photocathode and a screen, between which a voltage is applied. In a uniform electrostatic field of such an IIT, electrons are practically not focused (the electrons move along parabolas having parameters dependent on initial velocities of the electrons). For focusing of electrons, an IIT with a uniform electrostatic field is placed into a uniform magnetic field having the same direction as the electric field. In this case, the electrons emitted from individual points of the cathode, begin to move along periodically converging spiral paths rather than along the diverging parabolas. For obtaining a good electronic image, even without the use of a magnetic field, the aforementioned single-stage IITs utilize immersion-type electrostatic lenses, which are formed between the photocathode and anode and are made in the form of truncated conical bodies with the converging sides facing the cathodes. Normally, in such systems, potential of the anode is equal to the potential of the luminescent screen that is located directly behind the anode. The aforementioned lens collects the electrons emitted from the photocathode surface into narrow beams, which reproduce on the luminescent screen a visible image exactly corresponding to the image projected onto the photocathode. Simplified IITs of the type described above are capable of reproducing images with resolution capacity of several tens lines per mm. The lens reduces the image and thus improves the image brightness with the factor of several times. The opening at the converging end of the conical anode decreases optical feedback and thus shields the cathode from illumination by the luminescent screen.

The general opinion was that the resolution capacity of the single-stage IITs with electrostatic focusing and with flat cathodes and screens is limited by aberration of the electronic lenses, i.e., by two geometric aberrations such as astigmatism and distortion of the image surface and chromatic aberration such as scattering of velocities and angles of output of electrons that leave the photocathode. It was also considered that it is practically impossible to reduce the aforementioned aberration to the allowable range, e.g., by changing the geometry of electrodes. Therefore after 60's and 70', further development of IITs went in the direction of more complicated and sophisticated systems. Results of this development are reflected in modern multiple-stage IITs with the use of flat-concave fiber-optical electrodes, microchannel plates, etc.

A multiple-stage IIT that comprises several IITs connected in series can significantly increase brightness of the image. From the screen of the first IIT, a luminous flow is directed to a photocathode of the second IIT, and so on. Normally, a multiple-stage IIT is encapsulated into a common shell. In order to prevent significant loss of resolution capacity, the thickness of a transparent partition between the stages should not exceed 5 to 10 μm. Application of optical fiber plates makes it possible to connect individual IITs via direct optical contact between the surfaces of the plates. Multiple-stage IITs provide the maximum possible amplification of brightness when the output cathode-luminescent screen reproduces elements separately emitted from the photocathode. An IIT with a microchannel plate provides amplification of brightness close to the maximum possible limit. A microchannel plate is a glass plate with several million channels (having diameters within the range of 5 μm to 15 μm) with a voltage of about 1 kV applied to the end faces of this plate. In such an IIT, the electronic image is aligned with an input surface of the microchannel plate and is divided by the channels into separate elements. On its way through the channels, the electron flow of each element is multiplied by 10³ to 10⁴ times due to secondary emission of electrons caused by collision of the electrons with the walls of the channels. The obtained electronic image of amplified density is transferred to the screen.

The initial single-stage IITs of the type described above are known as zero- or first-generation IITs. An example of such a device can be found in U.S. Pat. No. 4,383,169 issued in 1983 to John Ashton. The device described in this patent contains a transparent input window. The input window is sealed by means of a glass frit seal to a cathode input window mounting flange. The mounting flange extends from a cathode body housing. Electrically connected to the cathode body housing, and hence to the mounting flange, is a getter shield. A ceramic body insulator separates the cathode body housing from an anode body housing. The anode body housing supports an anode focusing cone electrode. Mounted in an anode output window or screen mounting flange is a transparent output window. This window is scaled to the mounting flange by another glass frit seal.

At one end of the tube and carried by the input window is a photo-emissive cathode layer provided with a peripheral photo cathode metal contact layer, the latter making electrical contact with the mounting flange.

At the output end of the device and carried by the output window is a luminescent (phosphor) screen, which has an aluminum backing layer electrically united with the mounting flange.

Operating potential difference is created between the housings by means of a d.c. source.

The photoemissive layer is formed in two layers. One layer is of conventional form; it consists of fine grain particles of phosphor. Another layer, between the first layer and the aluminum-backing layer, consists of a silicate material having thermal properties such as to act as a heat sink.

In operation, the silicate layer acting as a heat sink tends to absorb the thermal energy generated in the aluminum backing layer as a result of a high energy input pulse, and thus tends to prevent localized melting of this aluminum layer. At the same time the silicate layer may be made sufficiently transparent to electrons as not seriously to interfere with the overall operation of the phosphor screen, and the screen conversion efficiency and modulation transfer function remain substantially unaffected despite the resistance of the device to damage by high energy light flashes.

In spite of its simplicity, even this IIT cannot be classified as an IIT of the zero or first generation because it provided with optical-fiber input and output windows, which per se significantly increase the cost of this IIT. Furthermore, this IIT cannot provide high characteristics inherent in modern IITs.

Development of subsequent second, third, and following stages each time accompanied by high increase in the cost of a final product. Thus for comparison, if the first-generation IIT has a cost from 20 US dollars to 50 dollars, a modern IIT with a microchannel plate nowadays costs more than 2000 US dollars, i.e., the cost has been raised by about two orders. Such high cost prevents the modern IITs form use in many fields of possible applications such as sensors, optical sights of general use, etc. An example of a device that utilizes an ITT of one of the latest generations is described in U.S. Pat. No. 6,072,565 issued in 2000 to J. Porter.

One basic parameter of an IIT is an integral sensitivity, which is a ratio of the photocurrent to a value of a light flow incident on the photocathode. For example, in an IIT with an oxygen-silver-cesium cathode intended for conversion of images in infrared rays with the wavelength of 1.3 μm, image sensitivity may reach 50 mkA/lumen. A multiple-alkaline photocathode which contains compounds of Sb with Cs, K, and Na and which is used in an IIT for amplification of a visible image, provides integral sensitivity up to 400 mkA/lumen. Other basic parameters are a resolution capacity (which is determined by the amount of separately seen black-and-white lines or dots per unit of length and which is within the range of 25 to 60 mm¹⁻¹, or higher); a coefficient of transformation (a ratio of the luminous flow emitted from the screen to the luminous flow incident on the photo-cathode, which reaches several hundred in single-stage IITs and 5×10⁴ in multiple-stage IITs); and time resolution (which in latest IITs reaches 10⁻¹² sec.). Constructions of IITs of the second and subsequent generations and their respective parameters listed above made it possible to use these IITs in night-vision systems, such as optical arm sights. Operation of these IITs in pulse modes made it possible to use them in range finders utilizing backlight systems for pulse illumination of objects, where illumination pulse may have time resolution of up to 10⁻¹² sec.

However, none of the existing IITs is suitable for mass production with the cost as low as the cost of IITs of the first generation.

### OBJECTS AND SUMMARY OF THE INVENTION

It is an object of the invention to provide an IIT which is simple in construction, small in size, reliable in operation due to small amount of parts, inexpensive to manufacture, and suitable for mass production and for use in devices and systems of general application, such as conventional telescopic sights, photo cameras for taking picture under poor vision conditions or at night, intrusion control systems working in a standby mode, or the like.

The IIT of the present invention consists of the following parts arranged in series along the optical axis of the IIT in the direction from the target being observed to the viewer's eye: a fiber-glass plate having a flat side facing the object and a concave side facing the viewer, a thin-film coating applied onto the concave surface of the fiber-glass plate which functions as a photo-cathode, an anode made in the form of a truncated cone with the narrow side facing the photo-cathode, and a flat luminescent screen made of glass with a luminescent coating. Unique parts of the IIT of the invention are a specially profiled and dimensioned anode and a shutter electrode. The anode and the shutter electrode have specific relationships between the diameters and lengths of the portions from which this parts are composed. The aforementioned specific relationships between the dimensions and shapes make it possible for the IIT to achieve the maximal resolution capacity and the coefficient of shuttering in a pulse mode of operation along with the minimal electrical capacitance of the shutter electrode and with the minimal shutter electrode voltage. The characteristics achieved in the IIT of the present invention are unattainable with the use of known IITs of similar type or generation.

### BRIEF DESCRIPTION OF THE DRAWING

FIG. 1 is a schematic longitudinal sectional view of an IIT of the invention.

### DETAILED DESCRIPTION OF THE INVENTION

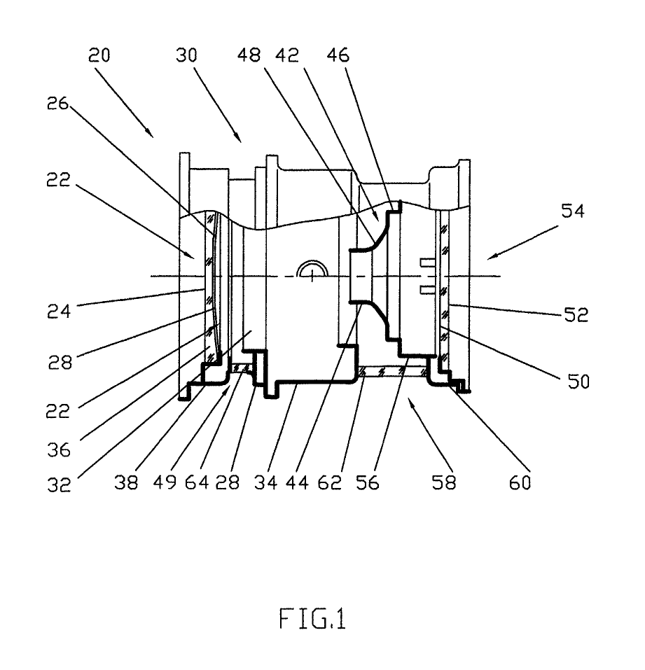

The IIT of the present invention is shown in FIG. 1, which is a schematic longitudinal sectional view of the device. The IIT, which as a whole is designated by reference 20, contains a fiberglass plate 22. One side 24 of the plate 22 is flat, and the other side 26 is concave and is coated with a thin-film coating 28 applied onto the concave surface 26 of the fiber-glass plate. The thin-film coating 28 may be made of SnO₂ or SnO₂ in a mixture with 10% to 20% of In₂O₂ and may have a thickness of about 500 to 1000 Angstroms. It can be applied, e.g., by a chemical vapor deposition or a physical vapor deposition method. The thin-film coating 28 is intended for use as a photo-cathode.

Located in front of the fiberglass plate 22 is a shutter electrode 30, which consists of a smaller cylindrical portion 32 and larger cylindrical portion 34. The smaller cylindrical portion 32 of the shutter electrode 30 faces the photo-cathode 28 and is spaced therefrom at a certain distance. The smaller cylindrical portion 32 and the larger cylindrical portion 34 of the shutter electrode are connected to each other.

The fiberglass plate 22 is sealingly inserted into a recess 36 of a cathode cylinder body 38. The recess 36 is formed on the outer side of the cathode cylinder body 38, which is opposite to the viewer's eye. The cathode cylinder body 38 is connected to the shutter electrode 30 by means of metal-ceramic soldering (not shown). Metal-ceramic soldering provides reliable sealing and electrically isolates the photo-cathode 28 from the shutter electrode 30.

The IIT 20 is provided with a specially profiled and dimensioned anode 42 consisting of a cylindrical part 44 of a small diameter on the cathode side, a cylindrical part 46 of a large diameter on the viewer's side, and a conical part 48 between the parts 44 and 46. The conical part 48 tapes from the large-diameter part 46 to the small-diameter part 44.

Reference numeral 50 designates a luminescent coating applied onto a substrate 52 to form a luminescent screen 54. The luminescent screen 54 is located on the outer side of the IIT facing the viewer's eye. Similar to the fiberglass plate 22 that supports the photo-cathode 28, the luminescent screen 54 seals the interior of the IIT formed between the aforementioned screen 54 and the fiberglass plate 22. The combined anode 42 and the luminescent screen 54 are connected via metallic cuffs 56 with a housing 58. This housing is formed by a cylindrical body 60, a glass cylindrical body 62, the large diameter part 34 of the shutter electrode 30, and a cylindrical glass spacer 64 sealingly connecting the shutter electrode 30 with the cathode cylinder body 38. The anode 42 has specific relationships between the diameters and lengths of the portions from which this anode is composed. The aforementioned specific relationships between the dimensions and shapes make it possible for the IIT to achieve the maximal resolution capacity of up to 50-70 lines/mm and the coefficient of shuttering in a pulse mode of operation of up to 10⁴ along with the minimal electrical capacitance of the shutter electrode 30 with respect to the photo-cathode 28 and with the minimal shutter electrode voltage. More specifically, the aforementioned maximal resolution capacity of the IIT and the minimal capacitance of the shutter electrode 30 with respect to the photo-cathode 28 for decrease in the shuttering time are achieved by combining the following four features: 1) decrease in the distance between the small-diameter part 32 of the shutter electrode 30 to the photo-cathode 28; 2) decrease in the operating surface area of the shutter electrode 30; 3) optimization of the shape of the anode with transfer from a known conical to a combined conical-cylindrical shape; and 4) decrease of the surface area of the concave-shaped photocathode 28 for diminishing electrical resistance in a dynamic mode of operation.

Experiments showed that the above objectives could be achieved only with the use of all four aforementioned features at the same time. Furthermore, the best results can be obtained at the following specific experimentally determined dimensions and ranges:

| | |
|---|---|
| Length of the cathode cylinder body 38 | from 1 to 2.8 mm |
| Length of the small diameter part 32 of the shutter | from 2 mm to 6.5 mm |
| electrode 30 | |
| Length of the large diameter part 34 of the shutter | from 12 mm to 18 mm |
| electrode 30 | |
| Height of the combined anode 42 | from 12 mm to 34 mm |

The best results with regard to the resolution capacity of the IIT and the shortest time of shuttering were obtained in a model of an IIT with the following dimension:

| | |
|---|---|
| Length of the cathode cylinder body 38 | 1.8 mm |
| Length of the small diameter part 32 of the shutter electrode | 4 mm |
| 30 | |
| Length of the large diameter part 34 of the shutter electrode | 15.8 mm |
| 30 | |
| Height of the combined anode 42 | 22.26 mm |
| Inner diameter of the small diameter part of the shutter | 12.5 mm |
| electrode 30 | |
| Length of the cylindrical part 44 of the anode 42 | 4.85 mm |
| Distance between the small diameter part 32 and the photo- | 3 mm |
| cathode 28 | |

The characteristics achieved in the IIT of the present invention are unattainable for known IITs of similar type or generation. For example, the IIT of the invention, which in its construction and cost is similar to the IITs of the first generation, made it possible to obtain shuttering period as short as 5 nsec.

The aforementioned special geometry of the anode and its physical parameters make it possible to use the anode as a shutter for temporary switching off the IIT, e.g., for using it as an element of a strobing system or for other purposes.

Main characteristics measured for IITs with dimensions within the aforementioned ranges specified by the present invention are shown below in Table 1.

CHARACTERISTICS

| | Resolution | | | | Shutter | | | |
|---|---|---|---|---|---|---|---|---|
| | Capacity | | Coefficient of | | Capacitance | | Lock voltage | |
| | (line/mm) | | Locking (10⁴) | | (pF) | | (V) | |
| | | Con- | | Con- | | Con- | | Con- |
| | Inven- | ven- | Inven- | ven- | Inven- | ven- | Inven- | ven- |
| No. | tion | tional | tion | tional | tion | tional | tion | tional |
| 1 | 52 | 45 to | 1 | 1 | <6 | 20 to | 540 | 1200 |
| 2 | 45 | 65 | 2 | | | 30 | 540 | to |
| 3 | 50 | | 1.5 | | | | 480 | 1700 |
| 4 | 52 | | 1 | | | | 550 | |
| 5 | 55 | | 1.8 | | | | 500 | |

Thus, it has been shown that the invention provides an IIT which is simple in construction, small in size, reliable in operation due to small amount of parts, inexpensive to manufacture, and suitable for mass production and for use in devices and systems of general application, such as conventional telescopic sights, photocameras for taking pictures under poor vision conditions or at night, intrusion control systems working in a standby mode, etc.

Although the invention has been described with reference to the specific embodiment and drawing, it is understood that these embodiment is shown only as an example and that many changes and modifications are possible within the scope of the attached patent claims. For example, the parts of the IIT can be made from materials different than those described. The fiberglass plate 22 can be replaced by a simple glass plate with insignificant loss of properties. The luminescent screen can be applied onto a flat fiberglass plate, or the photo-cathode plate 22 and the luminescent screen can be both supported by flat fiberglass plates. The glass cylindrical bodies 62 and 64 can be replaced by ceramic bodies. The glass-metal connections can be replaced by metal-ceramic connections. The specific dimensions were given only as an example and other dimensions can be used, provided they do not depart from the ranges specified by the present invention.

1. An image intensifier tube comprising:
a sealed hollow housing having a target side directed towards a target and a viewer side directed towards the viewer;
a photo-cathode on said target side having a cathode cylindrical body;
a luminescent screen on said viewer side;
a shutter electrode located in said housing between said target side and said viewer side; and
anode located in said housing between said shutter electrode and said luminescent screen;
said shutter electrode comprising an integral body consisting of a first cylindrical part and a second cylindrical part, said first cylindrical part facing said photo-cathode and has a diameter smaller than said second cylindrical part.

2. The image intensifier tube of claim 1, wherein said anode has a combined construction comprising a small-diameter part facing said shutter electrode, a large-diameter part facing said luminescent screen, and a truncated-conical part between said small-diameter part and said large-diameter part of said anode, said shutter electrode comprising a small-diameter part facing said photo-cathode and a large-diameter part facing said anode, said small-diameter part of said shutter electrode having an inner diameter.

3. The image intensifier tube of claim 1, wherein said shutter electrode is a part of said hollow sealed housing.

4. The image intensifier tube of claim 2, wherein said shutter electrode is a part of said hollow sealed housing.

5. The image intensifier tube of claim 1, wherein said photo-cathode comprises a fiber-glass plate having a target side flat and a viewer side concave and coated with a thin-film coating made of a compound selected from the group consisting of SnO₂ and SnO₂ together with In₂O₂.

6. The image intensifier tube of claim 2, wherein said photo-cathode comprises a fiber-glass plate having a target side flat and a viewer side concave and coated with a thin-film coating made of SnO₂ and SnO₂ together with In₂O₂.

7. The image intensifier tube of claim 3, wherein said photo-cathode comprises a fiber-glass plate having a target side flat and a viewer side concave and coated with a thin-film coating made of SnO₂ and SnO₂ together with In₂O₂.

8. The image intensifier tube of claim 4, wherein said photo-cathode comprises a fiber-glass plate having a target side flat and a viewer side concave and coated with a thin-film coating made of SnO₂ and SnO₂ together with In₂O₂.

9. The image intensifier tube of claim 2, wherein said cathode cylindrical body has the length within the range from 1 to 2.8 mm, said small-diameter part of said shutter electrode has the length within the range from 2 mm to 6.5 mm, said large-diameter part of said shutter electrode has the length within the range from 12 mm to 18 mm, and said anode has a height within the range from 12 mm to 34 mm.

10. The image intensifier tube of claim 9, wherein said cathode cylindrical body has the length of 1.8 mm, said small-diameter part of said shutter electrode has the length of 4 mm, said large-diameter part of said shutter electrode has the length of 15.8 mm said anode has a height of 22.26 mm, said small-diameter part of said shutter electrode has an inner diameter of 12.5 mm, said small-diameter part of said anode has a length of 4.85 mm, and a distance between said small-diameter part of said shutter electrode and said photo-cathode is equal to 3 mm.

11. The image intensifier tube of claim 4, wherein said cathode cylindrical body has the length within the range from 1 to 2.8 mm, said small-diameter part of said shutter electrode has the length within the range from 2 mm to 6.5 mm, said large-diameter part of said shutter electrode has the length within the range from 12 mm to 18 mm, and said anode has a height within the range from 12 mm to 34 mm.

12. The image intensifier tube of claim 11, wherein said cathode cylindrical body has the length of 1.8 mm, said small-diameter part of said shutter electrode has the length of 4 mm, said large-diameter part of said shutter electrode has the length of 15.8 mm said anode has a height of 22.26 mm, said small-diameter part of said shutter electrode has an inner diameter of 12.5 mm, said small-diameter part of said anode has a length of 4.85 mm, and a distance between said small-diameter part of said shutter electrode and said photo-cathode is equal to 3 mm.

13. The image intensifier tube of claim 6, wherein said cathode cylindrical body has the length within the range from 1 to 2.8 mm, said small-diameter part of said shutter electrode has the length within the range from 2 mm to 6.5 mm, said large-diameter part of said shutter electrode has the length within the range from 12 mm to 18 mm, and said anode has a height within the range from 12 mm to 34 mm.

14. The image intensifier tube of claim 13, wherein said cathode cylindrical body has the length of 1.8 mm, said small-diameter part of said shutter electrode has the length of 4 mm, said large-diameter part of said shutter electrode has the length of 15.8 mm said anode has a height of 22.26 mm, said small-diameter part of said shutter electrode has an inner diameter of 12.5 mm, said small-diameter part of said anode has a length of 4.85 mm, and a distance between said small-diameter part of said shutter electrode and said photo-cathode is equal to 3 mm.

15. An image intensifier tube, comprising:
a photo cathode;
a luminescent screen disposed in space relation relative to said photo cathode;
a shutter electrode disposed intermediate said photo cathode and said luminescent screen; and
an anode located intermediate the shutter electrode and the luminescent screen.

16. The image intensifier tube of claim 15, wherein said shutter electrode comprises an integral body consisting of a first cylindrical part and a second cylindrical part, said first cylindrical part facing said photo-cathode and has a diameter smaller than said second cylindrical part.

17. The image intensifier tube of claim 15, further comprising:
a sealed hollow housing having a target side directed towards a target and a viewer side directed towards the viewer;
said photo cathode being located on said target side and has a cathode cylindrical body;
said luminescent screen being located on said viewer side;
said shutter electrode being located in said sealed hollow housing between said target side and said viewer side; and
said anode being located in said sealed hollow housing between said shutter electrode and said luminescent screen.

18. The image intensifier tube of claim 16, wherein said shutter electrode comprises an integral body consisting of a first cylindrical part and a second cylindrical part, said first cylindrical part facing said photo-cathode and has a diameter smaller than said second cylindrical part.

19. The image intensifier tube of claim 16, wherein said anode has a combined construction comprising a small-diameter part facing said shutter electrode, a large-diameter part facing said luminescent screen, and a truncated-conical part between said small-diameter part and said large-diameter part of said anode, said shutter electrode comprising a small-diameter part facing said photo-cathode and a large-diameter part facing said anode, said small-diameter part of said shutter electrode having an inner diameter.

20. The image intensifier tube of claim 17, wherein said shutter electrode is a part of said hollow sealed housing.

21. The image intensifier tube of claim 15, wherein said photo-cathode comprises a fiber-glass plate having a target side flat and a viewer side concave and coated with a thin-film coating.

22. The image intensifier tube of claim 17, wherein said photo-cathode comprises a fiber-glass plate having a target side flat and a viewer side concave and coated with a thin-film coating.
